(19) United States
(12) Patent Application Publication
(10) Pub. No.: US 2010/0096074 A1
(43) Pub. Date: Apr. 22, 2010

(54) METHOD OF AND APPARATUS FOR MAKING A SPUNBOND LAMINATE

(76) Inventors: Marcus SCHOENBECK, Versmold (DE); Georg Baldauf, Laer (DE)

Correspondence Address: K.F. ROSS P.C., 5683 RIVERDALE AVENUE, SUITE 203 BOX 900, BRONX, NY, 10471-0900, US

(21) Appl. No.: 12/581,361

(22) Filed: Oct. 19, 2009

(30) Foreign Application Priority Data
Oct. 20, 2008 (EP) 08018308.0

(51) Int. Cl. B32B 37/15; B32B 5/12

(52) U.S. Cl. 156/176; 156/578

(57) ABSTRACT

An elastic nonwoven laminate is made by applying spaced zones of adhesive to a face of an elastic film such that adhesive-free zones are left between the adhesive zones. This elastic film carrying the adhesive zones is advanced in a travel direction, and an unconsolidated fleece nonwoven layer of filaments is applied to the face of the advancing film such that the fleece layer adheres to the film at the adhesive zones. The fleece layer can be formed by extruding a multiplicity of fibers or filaments and depositing them directly on the face of the film. Alternately they can be deposited on a conveyor that transports the fleece to the film and presses it against the film. Either way, the fleece layer is not consolidated and the fleece layer is not compacted prior to application to the glued side of the film.

### FIELD OF THE INVENTION

The present invention relates to a spunbond laminate. More particularly this invention concerns a spunbond laminate including an elastic film.

### BACKGROUND OF THE INVENTION

Items made of such a nonwoven or spunbond laminate are suitable for the production of, for example, hygiene products that need to have elastic properties. This how elastic closure strips or diaper tabs for diapers can be formed. In practice, such products usually require a soft surface made of a nonwoven material. Such an outer layer is advantageous, for example, in order to avoid or reduce the risk of irritation on direct skin contact. Surfaces made of nonwoven material that is comparatively soft is also often perceived by the customer as particularly high-quality and beneficial, regardless of the technical usefulness of the softness.

In processing elastic films the general problem exists that, due to the adhesive character of the elastic raw materials, adjacent turns of the film bond together when the film is wound into a roll. In order to avoid bonding of elastic film it is known to equip it with a separating paper that has to be removed during further processing at great expense, or powder that complicates gluing of the elastic film during its further processing.

It is further known from EP 1,686,209 to equip an elastic film with at least one outer nonwoven or fleece layer directly after extrusion. The fleece layer that is pulled off a roll and is applied to the elastic film by extrusion lamination or a hot-melt adhesive. During winding up of the elastic laminate formed in this manner the fleece layer forms a separating layer within the roll, thus preventing elastomer film from bonding to itself. One disadvantage is that due to the fed fleece layer the elastic properties of the laminate are significantly impaired.

A method of making an elastic composite film having a textile surface is known from EP 1,462,556. Here an elastic support is provided with short fibers. In case of a adhesion to spaced zones, large portions of the fiber material may detach and separate from the laminate in an undesired manner.

### OBJECTS OF THE INVENTION

It is therefore an object of the present invention to provide an improved method of and apparatus for making a spunbond laminate.

Another object is the provision of such an improved method of and apparatus for making a spunbond laminate that overcomes the above-given disadvantages, in particular that can be done cost-effectively and where the resultant nonwoven laminate simultaneously has good elastic properties and can be wound onto a roll without any risk of the film bonding to itself in adjacent turns.

A further object is to provide an improved apparatus for making such a composite material.

### SUMMARY OF THE INVENTION

An elastic nonwoven laminate is made according to the invention by applying spaced zones of adhesive to a face of an elastic film such that adhesive-free zones are left between the adhesive zones. This elastic film carrying the adhesive zones is advanced in a travel direction, and an unconsolidated fleece nonwoven layer of filaments is applied to the face of the advancing film such that the fleece layer adheres to the film at the adhesive zones.

The fleece layer can be formed by extruding a multiplicity of fibers or filaments and depositing them directly on the face of the film. Alternately they can be deposited on a conveyor that transports the fleece to the film and presses it against the film. Either way, the fleece layer is not consolidated, that is its fibers or filaments are not bonded together at their crossings and the fleece layer is not compacted prior to application to the glued side of the film. In addition the fleece is not stretched longitudinally, that is in a transport direction, or transversely before application to the film.

The melt-blown extrusion of the fleece layer is done by first forming fibers or filaments and then cutting them into fibers with an air knife. To this end, the melt-blown device that creates the fleece usually comprises an extruder having a nozzle or spinneret having number of holes next to one another. Directly after leaving the extrusion nozzle a pressurized-air stream is directed at the molten polymer strands exiting from the holes to stretch them.

It is essential to the invention that the fleece layer is deposited directly onto the elastic film or on the conveyor tat applies the layer to the film, free or substantially free of any tension of the elastic film. Since the two-dimensional layer is not rolled on and off, and no guiding of the nonwoven layer is provided under tension, it may be of very low strength, and particularly have a low mass per unit area. In this regard melt-blown fibers are characterized in that they are comparatively thin, and a good homogeneous coverage of the elastic film with a low mass per unit area, and a particularly soft appearance from the point of view of a user of the closed textile layer may be achieved.

According to the invention an inelastic thermoplastic polymer is used as the material for the melt-blown fibers, which is usually easy to process as compared to elastic materials or multicomponent fibers having an elastic core, and reliably prevents bonding during winding-up of the nonwoven laminate. Inelastic materials that can be used are, for example, polyolefins, such as polypropylene, polyethylene, but also polyamide, or polyethylene terephthalate.

According to the invention significant cost-savings may be achieved because the fleece layer can be made at a low mass per unit area from an inexpensive thermoplastic material. Since the melt-blown fibers may also be particularly easy to defibrate upon stretching of the laminate between the areas provided with adhesive, the elastic properties of the film are not substantially affected. In particular, the tension required for stretching is also not excessively increased. However, despite of the fraying or defibration a separating and loss of fibers may be avoided during stretching due to the anchoring of the fleece layer to the areas provided with adhesive.

The laminate according to the invention may be particularly suitable for use, for example, as an elastic closure strip on a diaper since no prior stretching is necessary for activation. It is also within the scope of the invention to connect the elastic laminate, as is known from prior art, to a further nonwoven, such as an SMS nonwoven, that is a three-layer laminate having a core layer made from melt-blown fibers between outer layers made from spunbond fibers. The lamination using additional nonwoven material is advantageous in order to increase breaking strength. However, in order to still be able to ensure an adequate ability for stretching, activation, e.g. prestretching, such as may occur in a roller gap of contoured, engaging rollers, is generally advantageous. By prestretching the material particularly also elastic and essentially inelastic areas, as well as a stretching threshold may be established.

A particularly advantageous embodiment is one in which the elastic nonwoven laminate according to the invention has a fleece layer that is directly applied to it, the additional nonwoven material being attached onto the opposite face of the elastic film. Within the scope of such an embodiment closure strips may be formed in a particularly cost-effective manner that have increased strength and a defined stretching threshold due to the additional nonwoven material and that are simultaneously provided with nonwoven material on both faces, thus having a high-quality appearance and pleasant feel.

According to a preferred embodiment of the method according to the invention the elastic film is formed in a first process step by flat-film extrusion, and provided with adhesive strips or zones immediately afterward without having to first be wound or unwound. According to the invention the various process steps are carried out one right after the other without intermediate storage or transport.

Preferably, a hot-melt adhesive is used as the adhesive and is applied to the elastic film, for example, by hot-melt nozzles in strips. An application of the adhesive in strips extending in longitudinal direction of the film is particularly preferred. To this end, the hot-melt nozzle may have various outlet openings arranged next to one another transversely in a particularly simple manner. They continuously dispense adhesive. The described alignment of the adhesive trips is also particularly advantageous if sections or strips are formed from the nonwoven laminate that preferably have a high transverse elasticity. Within the scope of such an embodiment the elasticity is not excessively transversely affected by the adhesive strips that are aligned perpendicular to the stretching direction in this case. Even if the hot-melt adhesive itself is inflexible, or largely inflexible, the longitudinally extending zones free of adhesive between the adhesive strips can be easily stretched transversely. In addition to completely straight adhesive strips an embodiment is also possible where the adhesive strips extend in wavy, spiral, or zigzag shape. This avoids an inadequate fastening of the lateral edges during formation of individual transversely stretchable strips made from the nonwoven laminate. To this end, the adhesive strips may overlap each other such that, for example, in case of adhesive strips in spiral shape, a mesh-like structure is formed.

The elastic film may also be provided on both faces with a layer of melt-blown nonwoven material within the scope of the method according to the invention, the direct application of the layers made from melt-blown nonwoven material on the elastic film, or the feeding of the melt-blown nonwoven material that is largely free of tension by the conveyor being carried out simultaneously or successively for the layers provided on both faces.

Particularly, if the nonwoven laminate according to the invention is intended for making diaper-closure strips, considerable stretching and stressing capacity of the elastic film is required. To this end, the elastic film preferably consists of a single-layer film of a thermoplastic elastomer, particularly a polymer from the group of styrol butadiene styrol copolymer (SBS), styrol isoprene styrol block copolymer (SIS), styrol ethylene butane copolymer (SEBS), other thermoplastic styrol elastomers (TPE-S), elastic polyolefin copolymer, thermoplastic polyolefin elastomer (TPE-O), thermoplastic polyurethane elastomer (TPE-U), thermoplastic polyamide elastomer (TPE-A), thermoplastic polyester elastomer (TPE-E), or a mixture of the polymers being suitable. In addition to utilizing single-layer films, multilayer coextruded films may also be used. The thickness of the elastic film is usually between 10 μm and 100 μm in the unstretched state.

The method according to the invention enables a cost-effective production of a nonwoven laminate overall, which is characterized by particularly advantageous elastic properties. According to the invention a layer made from melt-blown nonwoven material applied directly to the elastic film, or applied via a conveyor in a manner free of tension, is sufficient in order to avoid bonding, and to create a surface structure that is advantageous to the user without having an excessive adverse effect on the elastic properties of the nonwoven laminate determined by the elastic film.

If the adhesive is applied in strips, one face of the nonwoven laminate is completely covered by the layer made from melt-blown nonwoven material in the unstretched state, while this fleece layer is defibrated and the elastic film underneath it is exposed between the adhesive strips in the greatly stretched state. In case of an elastic return of the nonwoven laminate after the loss of tension, a surface is again observed that is completely covered by the melt-blown nonwoven material, which, however, is more voluminous manner due to the previous defibration of the individual melt-blown fibers that are usually extruded as endless fibers and that can be separated into finite pieces by an air knife.

The object of the invention is also an apparatus for carrying out the method described above. The apparatus comprises a flat-film extruder for forming the elastic film, an applicator for applying adhesive in zones, and a melt-blown device arranged such that a layer of melt-blown nonwoven material can be deposited directly onto the elastic foil or onto a conveyor. If the formed layer made from melt-blown nonwoven material is deposited directly onto the elastic film a conveyor is preferably provided in the area of the melt-blown device such that the elastic film is deposited there where the layer made from melt-blown nonwoven material contacts the conveyor. To this end, the conveyor uniformly guides and supports the elastic film web.

After the layer made from melt-blown nonwoven material has been deposited onto the elastic film the nonwoven laminate is usually passed through a roller gap. The roller gap mainly serves to secure the nonwoven material safely with the adhesive. Any modification of the structure of the nonwoven laminate by the influence of pressure and/or temperature is usually not provided beyond that.

### BRIEF DESCRIPTION OF THE DRAWING

The above and other objects, features, and advantages will become more readily apparent from the following description, reference being made to the accompanying drawing in which:

FIG. 1a is a schematic view of an apparatus for carrying out the method of this invention;

FIG. 2 is a view from above of a detail of the apparatus of FIG. 1a;

FIG. 2 is a view like FIG. 1 of another apparatus according to the invention;

FIG. 3 is another view like FIG. 1 of an apparatus in accordance with the invention; and

FIGS. 4a, 4b, and 4c are detail views illustrating the method of this invention.

### SPECIFIC DESCRIPTION

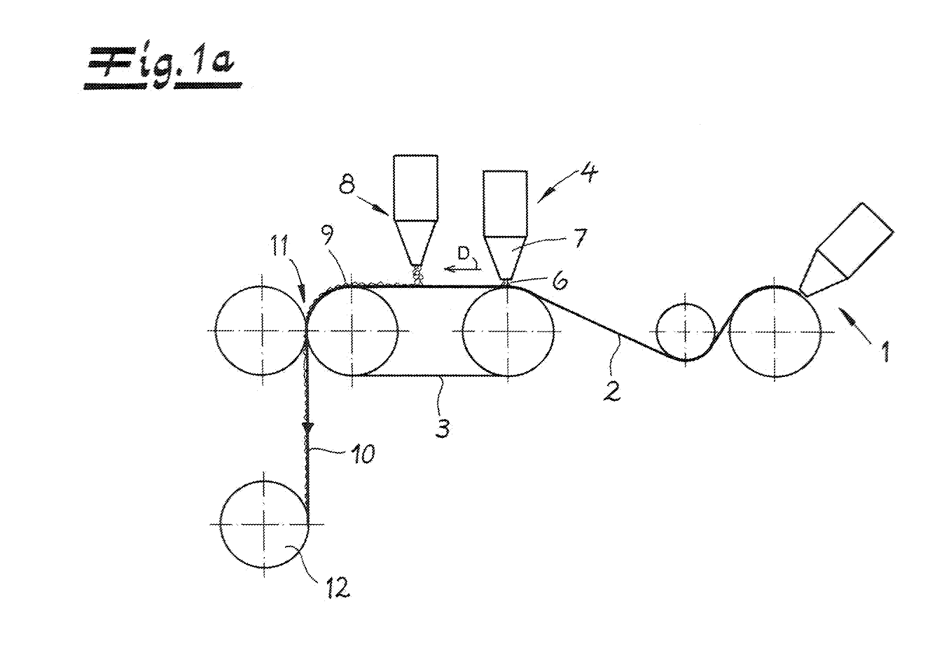

As seen in FIG. 1a, a flat-film extruder 1 forms an elastic film 2 that is immediately fed to a belt conveyor 3 whose continuously moving belt guides and transports the elastic film 2 in a horizontal transport direction D. The conveyor 3 moves of the elastic film 2 while supporting it from underneath without applying any significant tension to it, so that it is relaxed and not stretched.

At an upstream 6 end of the conveyor 3, an applicator 4 applies zones or strips 5 (see FIG. 1b) of a hot-melt adhesive to the film 2. The strips 5 as illustrated are applied as wavy lines spaced apart by a transverse distance equal to a multiple of the strip width, so that there are wide adhesive-free zones extending longitudinally, that is in the direction D, between the transversely spaced adhesive zones 5. The wavy shape of the strips 5 is achieved by transversely reciprocating an outlet nozzle 7 of the applicator 4.

The elastic film 2 carrying the hot-melt-adhesive strips 5 passes subsequently under a melt-blown device 8 that applies a layer 9 of a melt-blown fleece directly onto the elastic film 2 without prior consolidation. The resultant laminate 10 is subsequently guided through a roller nip or gap 11 in which the fleece layer 9 is pressed into the still molten hot-melt adhesive strips 5 with a slight pressure. The force acting upon the nonwoven laminate 10 in the roller gap 11 is selected such that no material reshaping of the fleece 9 occurs via pressure or temperature beyond the anchoring process. Subsequently, the nonwoven laminate 10 is wound onto a roller 12.

Since the strips 5 made from hot-melt adhesive strips 5, and the fibers of the layer 9 made from melt-blown nonwoven material extend essentially in the longitudinal direction X of the film 2, which is parallel to the transport direction D, the nonwoven laminate 10 is characterized by considerable transverse stretchability in the direction y. This transverse stretchiness is essentially determined by the elastic properties of the elastic film 2 and may be limited slightly at most by the fleece layer 9 and the hot-melt adhesive strips 5.

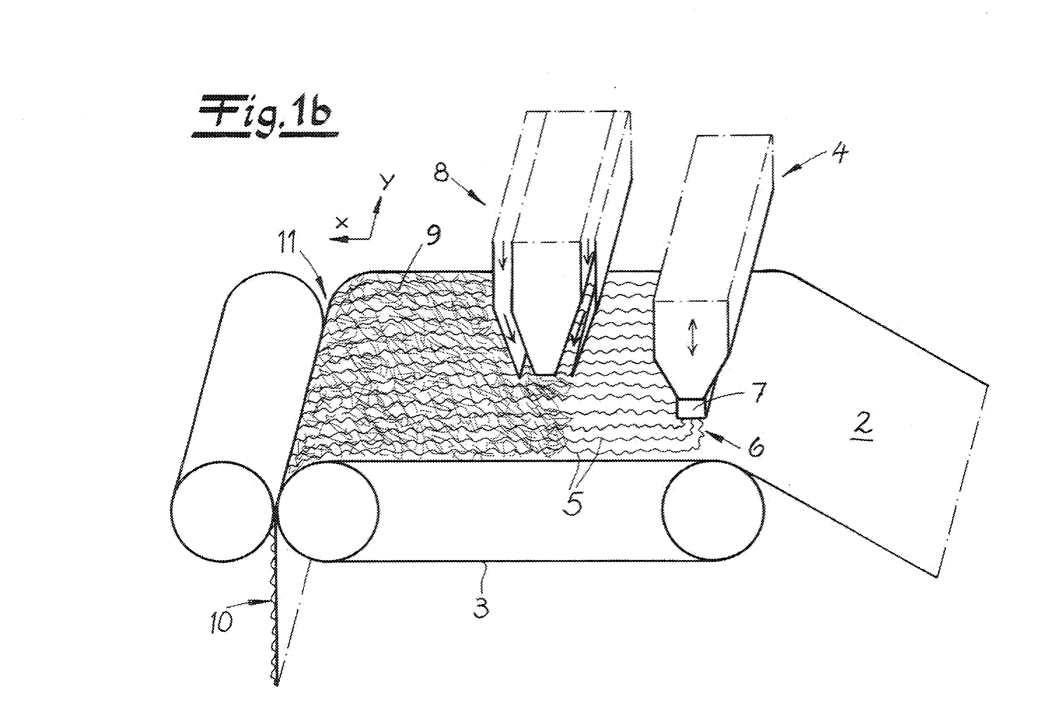

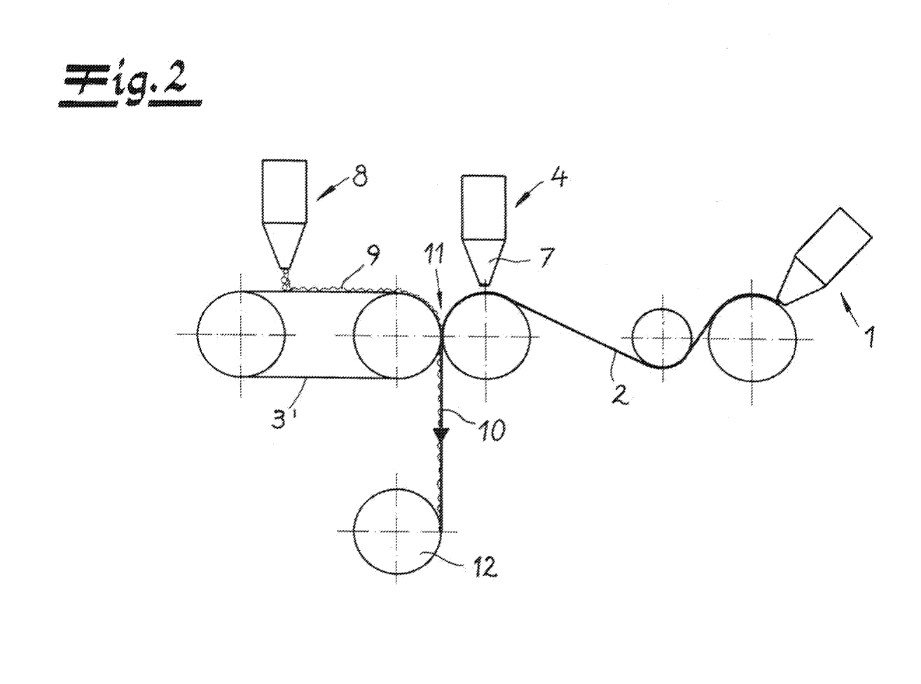

FIG. 2 shows an alternate embodiment of the apparatus where as in FIGS. 1a and 1b a fleece layer 9 is created by a melt-blown device 8. It is however not deposited directly onto the elastic film 2, but instead onto a conveyor 3′. As shown in FIG. 2 the conveyor 3′ may be a continuously moving belt with a horizontal upper stretch or a roller. The fleece layer 9 is fed to the elastic film 2 that was first provided with hot-melt adhesive strips 5, in a manner largely free of any tensions by the conveyor 3′, and as with the embodiment according to FIG. 1a, connected to the elastic film 2 at the sections provided with hot-melt adhesive strips 5.

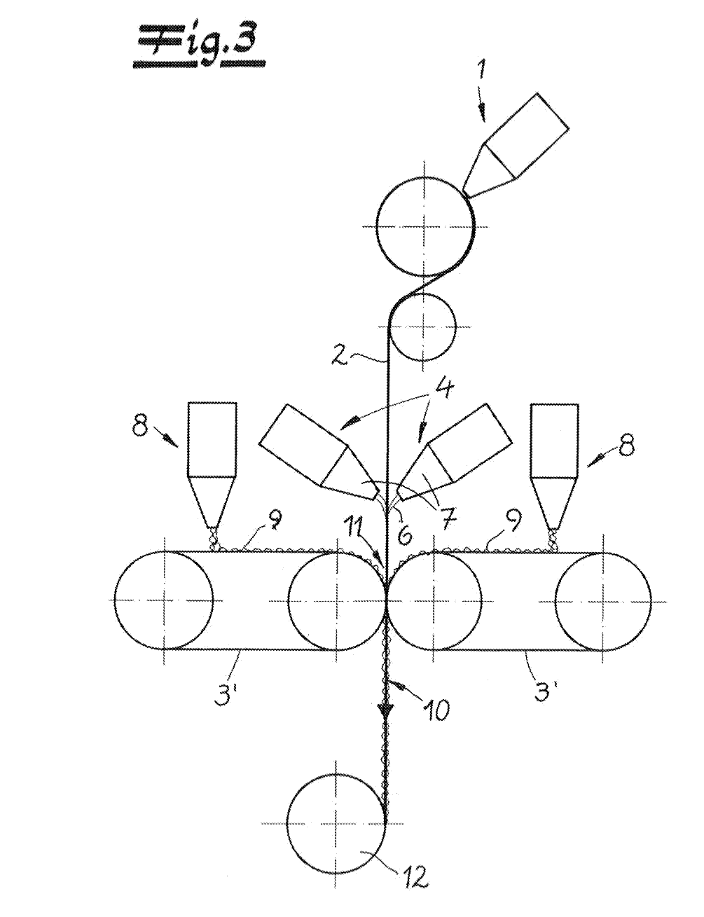

According to the further improvement of the apparatus as shown in FIG. 3 a second fleece layer 9 is formed and applied to both faces of the elastic film 2 by two such conveyors 3′. Of course in this case there are also two applicators 4 for applying strips 5 to both faces of the film 2 also.

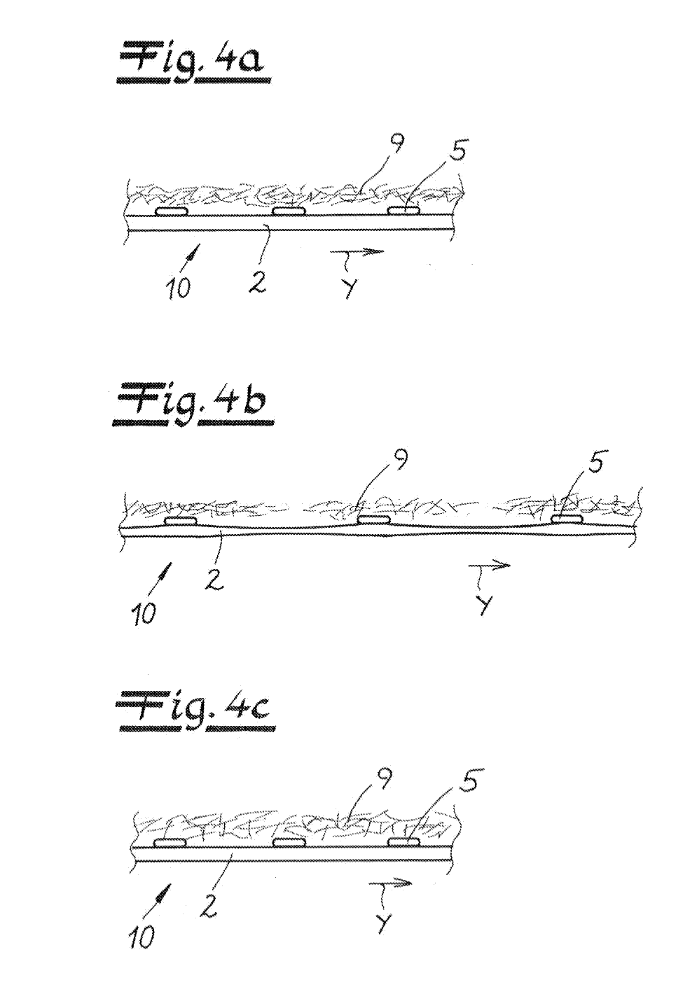

FIGS. 4a to 4c show a transverse section through the nonwoven laminate 10 produced according to the method according to the invention. As seen in FIG. 4a, the entire elastic film 2 is covered by the fleece layer 9 on one face. During stretching the melt-blown nonwoven material is defibrated, e.g. the fibers align and tear, which frees the elastic film 2 between the adhesive strips 5 in zones extending longitudinally (FIG. 4b). After the loss of the tensions and an elastic return of the section of the nonwoven laminate 10 the elastic film 2 is again covered by the fibers of the fleece layer 9 completely, or at least to a large extent. As seen in FIG. 4c, the fleece layer 9 is more voluminous because of the defibration after a first stretching process

I claim:

1. A method of making an elastic nonwoven laminate, the method comprising the steps of:
applying spaced zones of adhesive to a face of an elastic film such that adhesive-free zones are left between the adhesive zones;
advancing the elastic film carrying the adhesive zones in a travel direction; and
applying an unconsolidated fleece nonwoven layer of filaments to the face of the advancing film such that the fleece layer adheres to the film at the adhesive zones.

2. The laminate-making method defined in claim 1 wherein the fleece layer is applied to the face of the advancing film by
advancing the film horizontally with the face turned upward and
dropping the fleece from an overhead applicator directly onto the face.

3. The laminate-making method defined in claim 1 wherein the fleece layer is applied to the face of the advancing film by
dropping the fleece layer onto a horizontally advancing conveyor and
pressing the fleece layer with the conveyor against the face of the advancing film without substantially stretching the fleece layer.

4. The laminate-making method defined in claim 3 wherein the film is advanced vertically downward as the fleece layer is pressed by the conveyor against it.

5. The laminate-making method defined in claim 3, further comprising the steps of:
applying spaced zones of adhesive to an opposite face of the elastic film;
dropping another fleece layer onto another horizontally advancing conveyor; and
pressing the other fleece layer with the other conveyor against the opposite face of the advancing film without substantially stretching the other fleece layer.

6. The laminate-making method defined in claim 5 wherein both fleece layers are applied to the respective faces of the film at locations directly opposite each other.

7. The laminate-making method defined in claim 1, further comprising the step of
making the film with a flat-film extruder and immediately applying the adhesive strips without prior winding of the film.

8. The laminate-making method defined in claim 1 wherein the adhesive is a hot-melt adhesive that is applied hot and the fleece layer is applied to the face of the film before cooling of the adhesive.

9. The laminate-making method defined in claim 1 wherein the adhesive zones are applied as longitudinally extending strips, the method further comprising the steps after
applying the fleece layer to the face of the film of transversely elastically stretching the film and
rupturing some of the filaments between the strips and thereafter relaxing the strip.

10. An apparatus for making an elastic nonwoven laminate, the apparatus comprising:
means for advancing an elastic film in a travel direction;
means for applying spaced zones of adhesive to a face of the elastic film such that adhesive-free zones are left between the adhesive zones; and
means for applying an unconsolidated fleece nonwoven layer of filaments to the face of the advancing film such that the fleece layer adheres to the film at the adhesive zones.

11. The laminate-making apparatus defined in claim 10 wherein the means for applying zones of adhesive is an applicator that is longitudinally fixed such that the zones are longitudinally extending strips.

12. The laminate-making apparatus defined in claim 11, further comprising the step of
transversely reciprocating the applicator such that the strips are wavy.

13. The laminate-making apparatus defined in claim 10, further comprising
means for pressing the fleece layer against the face and into the adhesive zones.

14. The laminate-making apparatus defined in claim 10, further comprising
means for transversely elastically stretching the film after application to it of the fleece layer so as to tear the fleece layer between the adhesive zones.
